(19) United States
(12) Patent Application Publication
(10) Pub. No.: US 2025/0323966 A1
(43) Pub. Date: Oct. 16, 2025

(54) NON-TRANSITORY COMPUTER-READABLE RECORDING MEDIUM, STREAMING QUALITY ESTIMATION METHOD, AND STREAMING QUALITY ESTIMATION DEVICE

(71) Applicant: Fujitsu Limited, Kawasaki-shi (JP)

(72) Inventors: Akihiro WADA, Kawasaki (JP); Junki OURA, Kawasaki (JP); Kaoru YOKOO, Yokosuka (JP); Jun KAKUTA, Yokohama (JP); Teruhisa NINOMIYA, Yokohama (JP); Masatoshi OGAWA, Zama (JP); Kensuke SAWADA, Yokohama (JP)

(73) Assignee: Fujitsu Limited, Kawasaki-shi (JP)

(21) Appl. No.: 19/249,772

(22) Filed: Jun. 25, 2025

Related U.S. Application Data
(63) Continuation of application No. PCT/JP2023/045068, filed on Dec. 15, 2023.

(30) Foreign Application Priority Data
Feb. 15, 2023 (JP) 2023-021885

(51) Int. Cl. H04L 65/80; H04L 65/75

(52) U.S. Cl. CPC H04L 65/80; H04L 65/75

(57) ABSTRACT

A non-transitory computer-readable recording medium stores therein a program that causes a computer to execute a process including collecting packets related to streaming data delivered from a transmission source to a transmission destination, calculating a packet statistical value of a predetermined time period based on the collected packets, and creating, based on the calculated packet statistical value, an estimation model for estimating streaming quality using, as an input, a time series of packet statistical values corresponding to a time length exceeding a buffer time of the streaming data at the transmission destination.

### CROSS-REFERENCE TO RELATED APPLICATION

This application is a continuation of International Application No. PCT/JP2023/045068, filed on Dec. 15, 2023 which claims the benefit of priority of the prior Japanese Patent Application No. 2023-021885, filed on Feb. 15, 2023, the entire contents of which are incorporated herein by reference.

### FIELD

The embodiment discussed herein is related to a computer-readable recording medium, a streaming quality estimation method, and a streaming quality estimation device.

### BACKGROUND

In recent years, applications that handle streaming data such as video, audio, a web screen, and sensor data have increased, and network control for achieving appropriate quality (streaming quality) at the time of streaming reproduction has become increasingly important.

There are conventional technologies for obtaining quality of service (Qos) representing a network state from metadata in units of segments (video bit rate, resolution, stalling, and the like), packet statistical information (the number of packets, RTT), and the like as an index of network control for appropriately maintaining the streaming quality.
Patent Literature 1: Japanese Laid-open Patent Publication No. 2015-91012
Patent Literature 2: Japanese Laid-open Patent Publication No. 2015-12361
Patent Literature 3: U.S. Patent Application Publication No. 2020/0213211
Patent Literature 4: U.S. Patent Application Publication No. 2017/0366597
Non Patent Literature 1: Internet
<URL:.itu.int/rec/T-REC-P.1203>
Non Patent Literature 2: R. U. Mustafa, A Supervised Machine Learning Approach for DASH Video QoE Prediction in 5G Networks, Q2SWinet '20: Proceedings of the 16th ACM Symposium on QoS and Security for Wireless and Mobile Networks, 2020
Non Patent Literature 3: S. Wassermann, M. Seufert, P. Casas, L. Gang and K. Li, &quot;ViCrypt to the Rescue: Real-Time, Machine-Learning-Driven Video-QoE Monitoring for Encrypted Streaming Traffic,&quot; in IEEE Transactions on Network and Service Management, vol. 17, no. 4, pp. 2007-2023 Dec. 2020

### SUMMARY

According to an aspect of an embodiment, a non-transitory computer-readable recording medium stores therein a program that causes a computer to execute a process including collecting packets related to streaming data delivered from a transmission source to a transmission destination, calculating a packet statistical value of a predetermined time period based on the collected packets, and creating, based on the calculated packet statistical value, an estimation model for estimating streaming quality using, as an input, a time series of packet statistical values corresponding to a time length exceeding a buffer time of the streaming data at the transmission destination.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is an explanatory diagram illustrating an outline of a streaming quality estimation device according to an embodiment;

FIG. 2 is an explanatory diagram illustrating a streaming quality estimation device according to Example 1;

FIG. 3 is an explanatory diagram illustrating an example of an input/output data structure;

FIG. 4 is a block diagram illustrating a functional configuration example of the streaming quality estimation device according to Example 1;

FIG. 5 is a flowchart illustrating an operation example of the streaming quality estimation device according to Example 1;

FIG. 6 is an explanatory diagram illustrating estimation of a buffer time;

FIG. 7 is an explanatory diagram illustrating estimation of the buffer time;

FIG. 8 is a block diagram illustrating a functional configuration example of a streaming quality estimation device according to Example 2;

FIG. 9 is a flowchart illustrating an operation example of the streaming quality estimation device according to Example 2;

FIG. 10 is an explanatory diagram illustrating accuracy comparison between a conventional technology and an example;

FIG. 11 is an explanatory diagram illustrating a streaming quality estimation device according to Example 3; and

FIG. 12 is an explanatory diagram illustrating an example of a computer configuration.

### DESCRIPTION OF EMBODIMENTS

However, the above-described conventional technologies are not for accurate and real-time estimation of streaming quality from packet data. Thus, for example, even in a case where network control is performed using the streaming quality estimated by the conventional technologies as an index, it is difficult to achieve streaming reproduction users will be satisfied with.

Preferred embodiments will be explained with reference to accompanying drawings. In the embodiment, components having the same function are denoted by the same reference numerals, and redundant description will be omitted. Note that the computer-readable recording medium, the streaming quality estimation method, and the streaming quality estimation device described in the following embodiment are merely examples, and do not limit the embodiment. In addition, the following embodiments may be appropriately combined within a range that involves no contradiction.

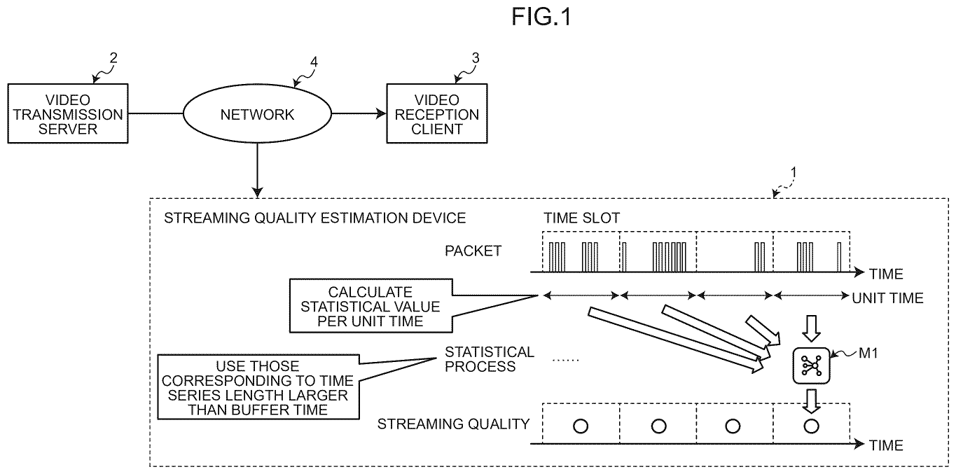

FIG. 1 is an explanatory diagram illustrating an outline of the streaming quality estimation device according to the embodiment. As illustrated in FIG. 1, a streaming quality estimation device 1 is a device that collects a packet group related to streaming data of a video (for example, a moving image) transmitted from a video transmission server 2 to a video reception client 3 via a network 4, and estimates streaming quality on the basis of information of the packet group.

Here, the video transmission server 2 is an example of a transmission source of the streaming data, and the video reception client 3 is an example of a transmission destination of the streaming data. Furthermore, the embodiment exemplifies streaming data related to a video, but the streaming data is not limited to a video, and may be audio, a web screen, sensor data, or the like.

The streaming quality estimation device 1 monitors packets flowing through the network 4, and collects a packet group of streaming data transmitted from the video transmission server 2 to the video reception client 3. Next, the streaming quality estimation device 1 calculates a packet statistical value (for example, the number of packets, data amount, packet interval, and the like) for each unit time (time slot) for the collected packet group.

For example, in a case where streaming reproduction of streaming data is performed by an application (for example, a video reproduction application), the video reception client 3 sequentially transmits request packets requesting streaming data to the network 4, and performs streaming reproduction using the streaming data obtained between the request packets. Therefore, an interval between the request packets corresponds to the time during which the streaming data is used by the video reception client 3 (hereinafter referred to as a data use time).

In the streaming quality estimation device 1, the unit time (time slot) is set to be equal to or less than the above-described data use time in order to obtain subtleties of changes related to packets of streaming data.

As for the method of determining the data use time, in a case where the target application has been determined in advance and known, the value thereof is used. For example, in a case of a video reproduction application, the time corresponding to a segment length is set as the data use time. Furthermore, in a case where the data use time is unknown, the streaming quality estimation device 1 measures the intervals at which the video reception client 3 issues request packets, and sets an average value thereof as the data use time. In addition, in a case where there is a plurality of data use times, the shortest data use time among the plurality of data use times is adopted.

Next, on the basis of the calculated packet statistical value for each unit time, the streaming quality estimation device 1 inputs, to an estimation model M1, a time series of packet statistical values corresponding to a time length exceeding a buffer time of an application for performing streaming reproduction in the video reception client 3. Specifically, the streaming quality estimation device 1 sequentially inputs, to the estimation model M1 in chronological order, packet statistical values corresponding to a time length (hereinafter referred to as a time series length) exceeding the buffer time.

In the application for performing streaming reproduction in the video reception client 3, a buffer is prepared so that the streaming reproduction is not interrupted. This causes a deviation between packet arrival time and data use time (reproduction time). The magnitude of this deviation corresponds to the buffer time at the maximum.

In order to estimate the streaming quality while eliminating such a deviation, the streaming quality estimation device 1 inputs, to the estimation model M1, packet statistical values corresponding to a time length (time series length) exceeding the buffer time.

In a case where the application for performing streaming reproduction in the video reception client 3 is known on the basis of packet information or the like monitored by the streaming quality estimation device 1, the streaming quality estimation device 1 sets the longest buffer time in the application as the time length.

In a case where the application is unknown, the streaming quality estimation device 1 selects, as the time length, the longest buffer time in an assumed application. Alternatively, the streaming quality estimation device 1 may prepare a plurality of estimation models M1 that differ from each other in time series length (time length) used as an input for estimating the streaming quality, and estimate the buffer time on the basis of estimation accuracies of the streaming qualities in a case where packet statistical values are input to each of the plurality of estimation models M1 (see Example 2).

The estimation model M1 is a neural network or the like in which parameters have been adjusted by known machine learning. For packet statistical values of the time series length sequentially input in chronological order, the estimation model M1 outputs (estimates) the streaming quality corresponding to the time series length. That is, the streaming quality estimation device 1 collects packets of streaming data flowing through the network 4 in real time, and sequentially inputs the packet statistical values corresponding to the time series length to the estimation model M1, thereby estimating the streaming quality for each time series length in real time.

In addition, the streaming quality estimation device 1 performs machine learning of the estimation model M1 on the basis of training data to which the streaming quality for each unit time has been given as ground truth information together with the streaming data, and creates the estimation model M1. Specifically, the streaming quality estimation device 1 sequentially inputs, to the estimation model M1, the packet statistical values corresponding to the time series length based on the streaming data, and adjusts parameters of the estimation model M1 so that the estimation model M1 outputs the streaming quality of the ground truth information by a known machine learning method such as backpropagation.

Here, it is assumed that the streaming quality as the ground truth information includes not only the Qos but also quality of experiment (QoE), which is the quality of user's experience. The QoE includes a value (for example, a mean opinion score (MOS) value) obtained by aggregating subjective evaluations of users who have experienced streaming reproduction (for example, have watched a streaming video) by a questionnaire or the like. As a result, the streaming quality estimation device 1 can estimate not only the Qos but also the QoE as the streaming quality in real time.

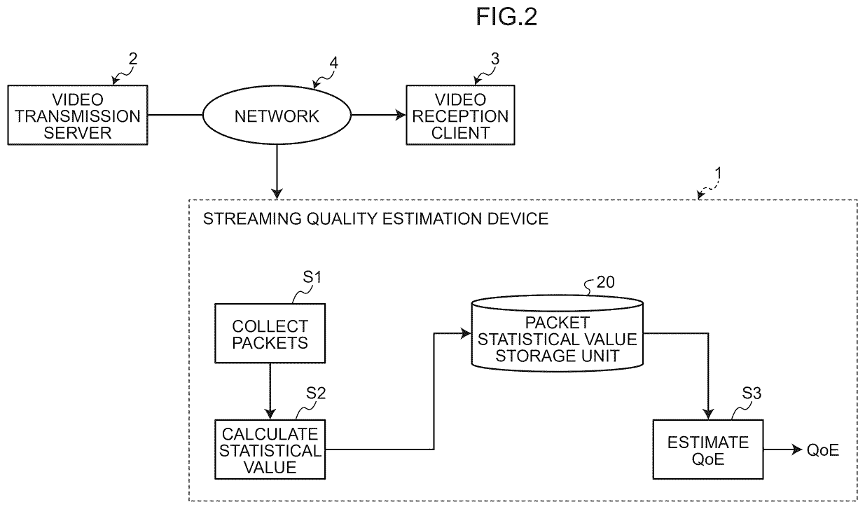

Hereinafter, Examples 1 to 3 according to the above-described embodiment will be described with reference to FIGS. 2 to 11.

### Example 1

FIG. 2 is an explanatory diagram illustrating a streaming quality estimation device according to Example 1. As illustrated in FIG. 2, a streaming quality estimation device 1 monitors packets flowing through a network 4, and collects packets of streaming data transmitted from a video transmission server 2 to a video reception client 3 (S1).

Next, the streaming quality estimation device 1 calculates a packet statistical value (for example, the number of packets, data amount, packet interval, and the like) for each unit time (time slot) (S2). The streaming quality estimation device 1 stores the packet statistical value calculated for each unit time in a packet statistical value storage unit 20.

The streaming quality estimation device 1 sequentially estimates the streaming quality (QoE) for each time series length by sequentially inputting the packet statistical values corresponding to the time series length to an estimation model M1 with reference to the packet statistical value storage unit 20 (S3).

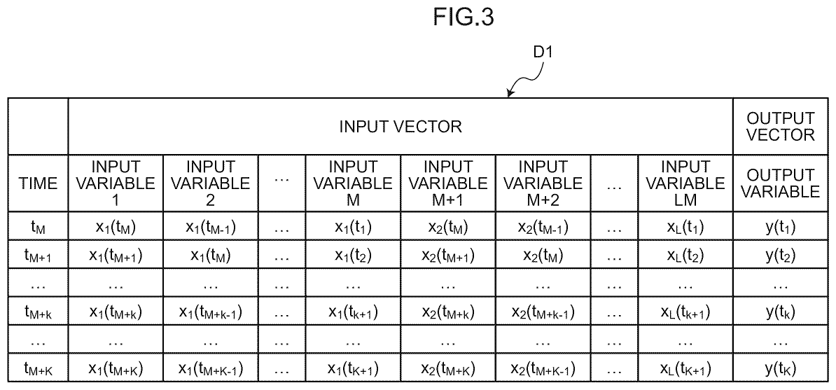

FIG. 3 is an explanatory diagram illustrating an example of an input/output data structure. As illustrated in FIG. 3, input/output data DI is a set of input data (input vector) and output data (output vector) for each time (t_{M}, t_{M+1} . . . , t_{M+k}, . . . t_{M+K}).

Specifically, the input/output data D1 exemplifies an input vector input to the estimation model M1 and an output vector from the estimation model M1 in a case where the number of types of packet statistical values (for example, the number of packets, data amount, packet interval, . . . , and the like) is L and the time series length is M unit times. For example, an input variable of the input vector is a packet statistical value such as the number of packets, a data amount, or a packet interval. Furthermore, an output variable of the output vector is the streaming quality (QoE, Qos, . . . ) output from the estimation model M1.

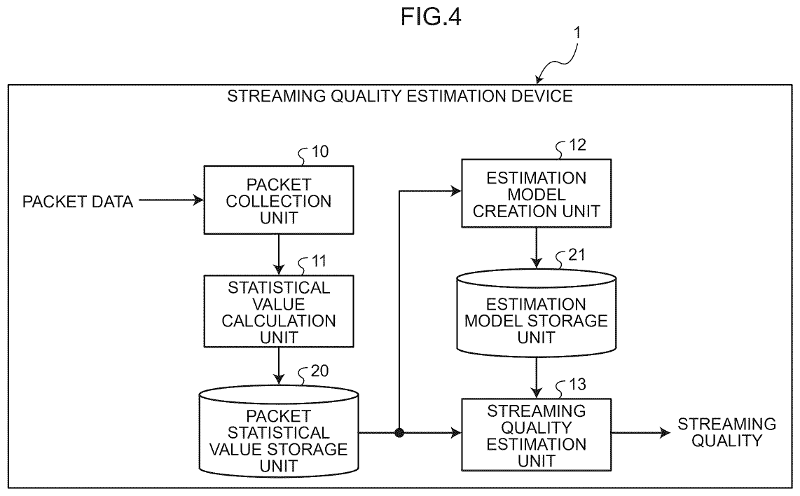

FIG. 4 is a block diagram illustrating a functional configuration example of the streaming quality estimation device 1 according to Example 1. As illustrated in FIG. 4, the streaming quality estimation device 1 includes a packet collection unit 10, a statistical value calculation unit 11, an estimation model creation unit 12, a streaming quality estimation unit 13, the packet statistical value storage unit 20, and an estimation model storage unit 21.

The packet collection unit 10 acquires packet data transmitted from the video transmission server 2 to the video reception client 3 via the network 4 on the basis of headers or the like of packets, and collects a packet group of streaming data.

On the basis of the packet group collected by the packet collection unit 10, the statistical value calculation unit 11 calculates a packet statistical value (for example, the number of packets, data amount, packet interval, and the like) for each unit time (time slot). The statistical value calculation unit 11 stores the calculated packet statistical value in the packet statistical value storage unit 20 as the above-described input vector data for each time.

The estimation model creation unit 12 is a processor that performs machine learning of the estimation model M1 on the basis of training data to which the streaming quality for each unit time has been given as ground truth information together with the streaming data. Specifically, the estimation model creation unit 12 sequentially reads, from the packet statistical value storage unit 20, the packet statistical values corresponding to the time series length based on the streaming data, and inputs the packet statistical values to the estimation model M1. Next, the estimation model creation unit 12 adjusts the parameters of the estimation model M1 so that the estimation model M1 outputs the streaming quality of the ground truth information by a known machine learning method. The estimation model creation unit 12 stores, in the estimation model storage unit 21, the estimation model M1 after the parameter adjustment.

The streaming quality estimation unit 13 is a processor that estimates the streaming quality for each time series length on the basis of the packet data collected by the packet collection unit 10. Specifically, the streaming quality estimation unit 13 reads, from the estimation model storage unit 21, parameters related to the estimation model M1 created by the estimation model creation unit 12, and generates the estimation model M1. Next, the streaming quality estimation unit 13 sequentially reads the packet statistical values corresponding to the time series length based on the streaming data from the packet statistical value storage unit 20, and inputs the packet statistical values to the generated estimation model M1. As a result, the streaming quality estimation unit 13 obtains an output of the estimation model M1, that is, an estimation result of the streaming quality for each time series length.

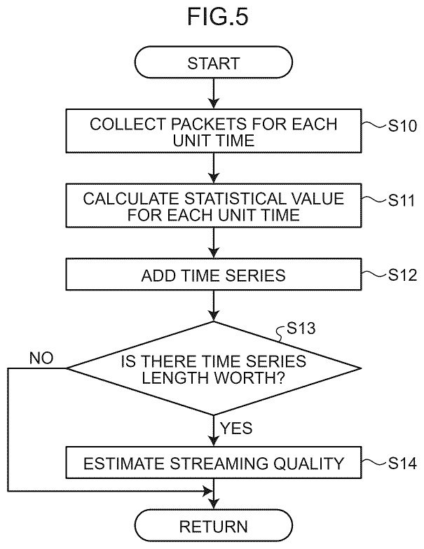

FIG. 5 is a flowchart illustrating an operation example of the streaming quality estimation device 1 according to Example 1. As illustrated in FIG. 5, the packet collection unit 10 collects packets for each unit time for packet data transmitted from the video transmission server 2 to the video reception client 3 (S10).

Next, the statistical value calculation unit 11 calculates a statistical value (e.g., the number of packets, data amount, or packet interval) of the collected packets for each unit time (S11), and adds the statistical values to the packet statistical value storage unit 20 in chronological order (S12).

Next, the streaming quality estimation unit 13 determines whether the packet statistical values corresponding to the time series length have been stored in the packet statistical value storage unit 20 (S13). If the packet statistical values corresponding to the time series length have been stored (S13: Yes), the streaming quality estimation unit 13 reads the packet statistical values corresponding to the time series length from the packet statistical value storage unit 20, inputs the packet statistical values to the estimation model M1, estimates the streaming quality (S14), and returns the process to S10. If the packet statistical values corresponding to the time series length have not been stored (S13: No), the streaming quality estimation unit 13 returns the process to S10 without estimating the streaming quality.

### Example 2

Example 2 is obtained by adding, to Example 1, a process of estimating a buffer time in a case where the application for performing streaming reproduction in the video reception client 3 is unknown and a time series length exceeding the buffer time is unknown.

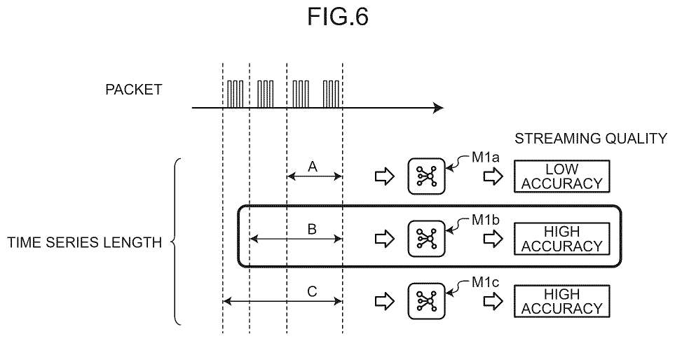

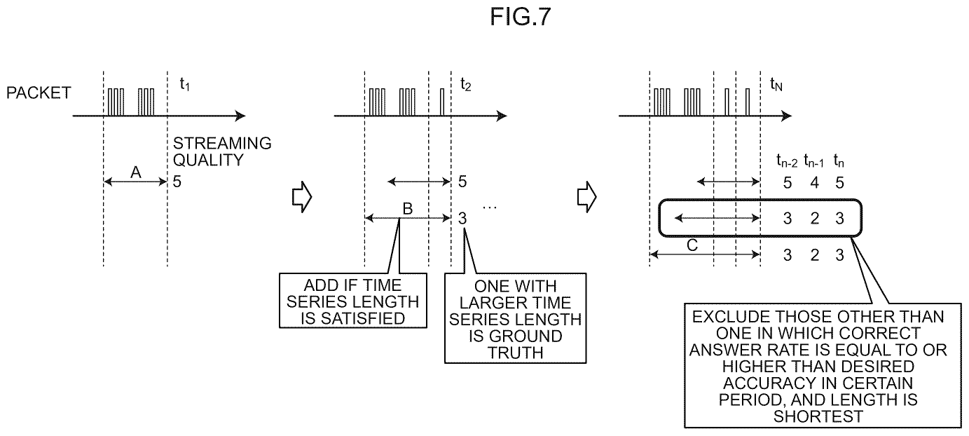

FIGS. 6 and 7 are explanatory diagrams illustrating estimation of the buffer time. As illustrated in FIG. 6, in Example 2, a plurality of estimation models M1a to M1c that differ from each other in time series length (time length) used as an input for estimating streaming quality are prepared and stored in an estimation model storage unit 21.

Next, in Example 2, the estimation accuracy of the streaming quality in a case where packet statistical values are input to each of the estimation models M1a to M1c is obtained. Note that, for the estimation accuracy, a known machine learning model performance evaluation method may be used, and an accuracy rate is obtained as an example.

Here, a case where the accuracy rate is low indicates that the time series length of the estimation model is less than the buffer time, and the deviation of data reproduction time due to the buffer time has not been eliminated. Conversely, a case where the accuracy rate is equal to or higher than a predetermined value indicates that the time series length of the estimation model is equal to or larger than the buffer time, and the deviation of the data reproduction time due to the buffer time has been eliminated.

Therefore, in Example 2, from among the estimation accuracies individually obtained for the estimation models M1a to M1c, one in which the estimation accuracy exceeds a predetermined threshold and the time series length is the shortest is selected. In Example 2, the time series length selected in this manner is set as the buffer time.

For example, as illustrated in FIG. 7, in Example 2, packet statistical values corresponding to a time series length A are input to the estimation model M1a, and thus the streaming quality in the estimation model M1a is obtained. Next, in Example 2, packet statistical values corresponding to a time series length B, which is the largest next to the time series length A, are input to the estimation model M1b, and thus the streaming quality in the estimation model M1b is obtained. Next, in Example 2, a difference between the estimated value of the streaming quality in the estimation model M1a and the estimated value of the streaming quality in the estimation model M1b is obtained, and it is determined whether the difference falls within a predetermined threshold.

If the difference does not fall within the predetermined threshold, in Example 2, packet statistical values corresponding to a time series length C, which is the largest next to the time series length B, are input to the estimation model M1c, and thus the streaming quality in the estimation model M1c is obtained. Next, in Example 2, a difference between the estimated value of the streaming quality in the estimation model M1b and the estimated value of the streaming quality in the estimation model M1c is obtained, and it is determined whether the difference falls within the predetermined threshold. Here, if the difference falls within the predetermined threshold, in Example 2, the estimation accuracy of each streaming quality is obtained, and the one in which the accuracy is equal to or higher than a desired accuracy and the time series length is the shortest is selected.

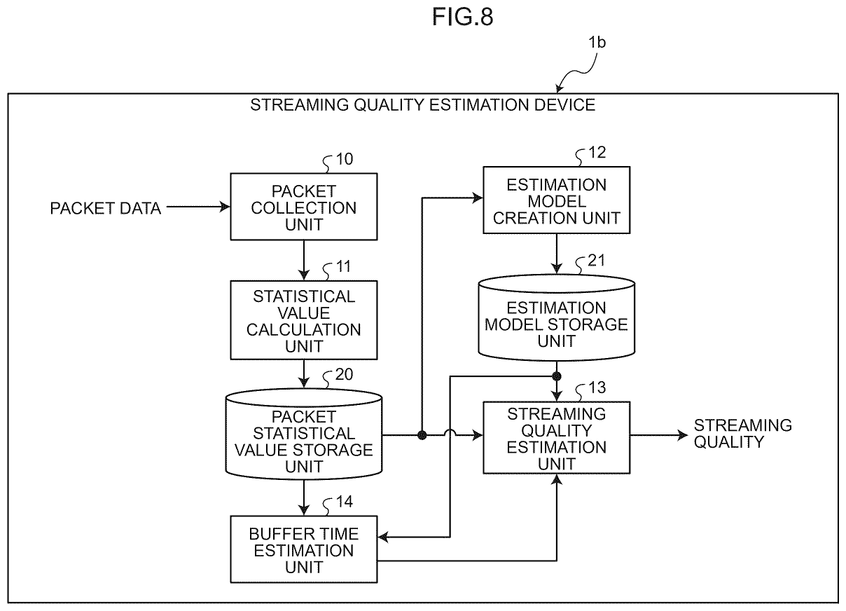

FIG. 8 is a block diagram illustrating a functional configuration example of a streaming quality estimation device according to Example 2. As illustrated in FIG. 8, a streaming quality estimation device 1b has a configuration in which a buffer time estimation unit 14 is added to the streaming quality estimation device 1 of Example 1.

The buffer time estimation unit 14 reads the plurality of estimation models M1a to M1c stored in the estimation model storage unit 21, and estimates the buffer time on the basis of the estimation accuracy of the streaming quality in a case where the packet statistical values are input to each of the estimation models M1a to M1c.

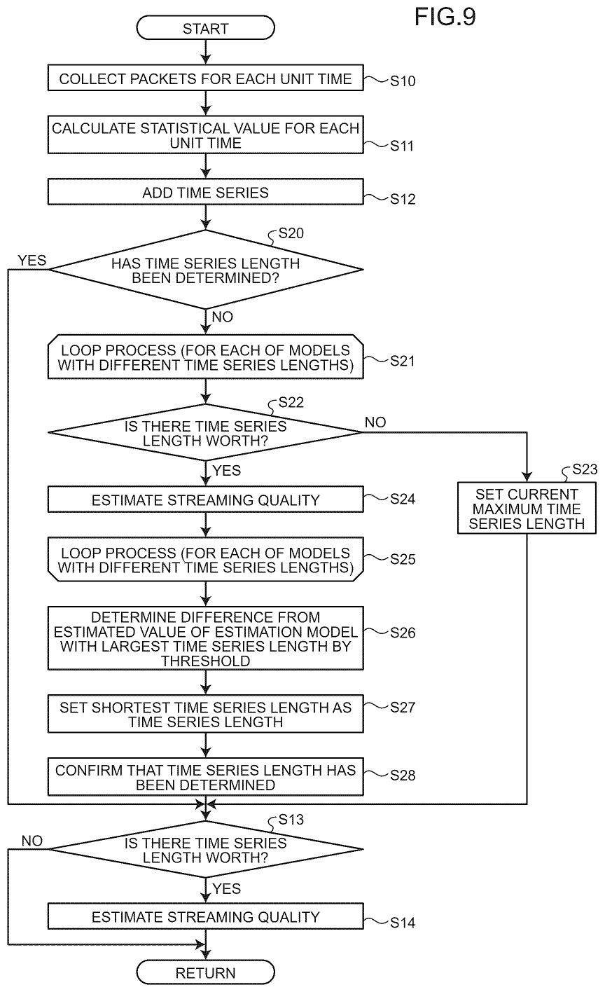

FIG. 9 is a flowchart illustrating an operation example of the streaming quality estimation device 1b according to Example 2. As illustrated in FIG. 9, in the streaming quality estimation device 1b, a process of estimating the buffer time (S20 to S28) is added between S12 and S13.

Specifically, the buffer time estimation unit 14 determines whether the time series length has been determined (the buffer time has been estimated) (S20). If the estimation has been completed (S20: Yes), the buffer time estimation unit 14 advances the process to S13.

If the estimation has not been completed (S20: No), the buffer time estimation unit 14 performs a loop process for each of the estimation models M1a to M1c with different time series lengths (S21 to S25).

When the loop process is started, the buffer time estimation unit 14 determines whether packet statistics corresponding to the time series length that correspond to inputs of the estimation models M1a to M1c have been stored in a packet statistical value storage unit 20 (S22). If the packet statistics corresponding to the time series length have not been stored in the packet statistical value storage unit 20 (S22: No), the buffer time estimation unit 14 sets the current maximum time series length (S23), and advances the process to S13.

If the packet statistics corresponding to the time series length have been stored in the packet statistical value storage unit 20 (S22: Yes), the buffer time estimation unit 14 inputs the packet statistics corresponding to the time series length to the estimation models M1a to M1c, and estimates the streaming qualities (S24).

Following the loop process (S21 to S25), the buffer time estimation unit 14 determine, by a predetermined threshold, a difference between the estimated value (streaming quality) of the estimation model with the largest time series length and the estimated value obtained by the loop process (S26).

If the difference falls within the predetermined threshold, the buffer time estimation unit 14 obtains the estimation accuracy of each streaming quality, and sets, as a time series length (buffer time), one in which the accuracy is equal to or higher than the desired accuracy and the time series length is the shortest (S27).

Next, the buffer time estimation unit 14 confirms that the time series length (buffer time) has been determined (S28), and advances the process to S13.

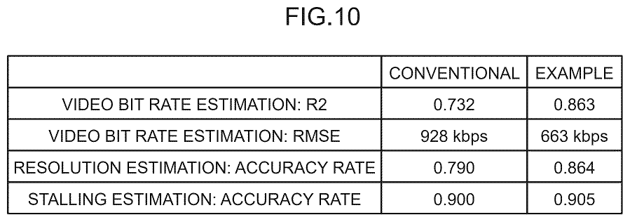

FIG. 10 is an explanatory diagram illustrating accuracy comparison between a conventional technology and an example. FIG. 10 illustrates a comparison between estimation of the streaming quality according to the conventional technology and estimation of the streaming quality according to Example 1, using a packet group (streaming data) when a moving image corresponding to about 136 hours is delivered.

Note that, in the estimation of the streaming quality according to Example 1, the unit time is 0.5 seconds, and the time series length is 40 seconds. R2 is an index value indicating that the closer to 1, the higher the accuracy. RMSE is an index value indicating that the closer to 0, the higher the accuracy. The accuracy rate is an index value indicating that the closer to 1, the higher the accuracy. As illustrated in FIG. 10, Example 1 provides an improvement in the estimation accuracy of the streaming quality as compared with the conventional technology.

### Example 3

Example 3 is obtained from Example 1 by estimating metadata (e.g., video bit rate, resolution, or stalling) for each unit time and then sequentially inputting the metadata corresponding to the time series length to an estimation model M1, thereby estimating the streaming quality for each time series length.

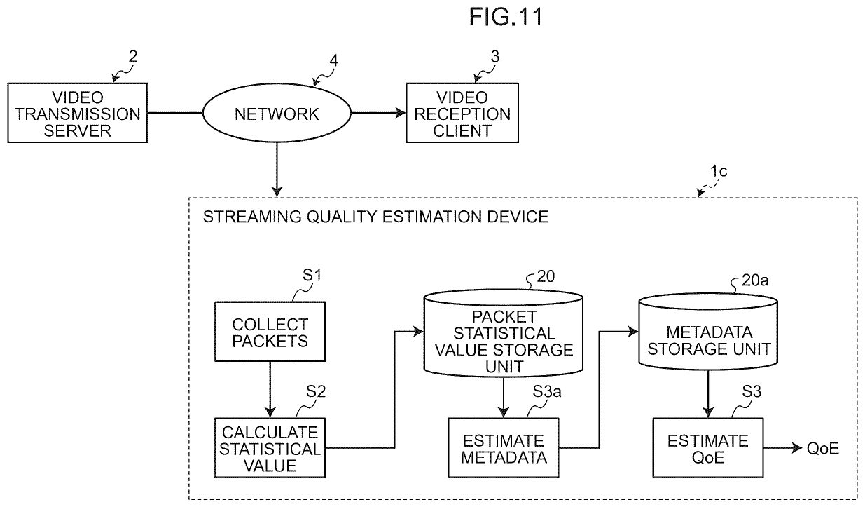

FIG. 11 is an explanatory diagram illustrating a streaming quality estimation device according to Example 3. As illustrated in FIG. 11, a streaming quality estimation device 1c estimates the metadata for each unit time by sequentially inputting packet statistical values corresponding to the unit time to the estimation model of the metadata with reference to a packet statistical value storage unit 20 (S3a). The streaming quality estimation device 1c stores, in a metadata storage unit 20a, the metadata estimated for each unit time.

Next, the streaming quality estimation device 1c sequentially estimates the streaming quality (QoE) for each time series length by reading the metadata corresponding to the time series length from the metadata storage unit 20a and inputting the metadata to a trained estimation model as an input vector (S3).

The streaming quality estimation device may estimate the streaming quality for each time series length via the metadata in this manner.

As described above, the streaming quality estimation devices 1 and 1b collect packets related to streaming data delivered from a transmission source to a transmission destination. The streaming quality estimation devices 1 and 1b calculate a packet statistical value of a predetermined time period on the basis of the collected packets. The streaming quality estimation devices 1 and 1b create, on the basis of the calculated packet statistical value, the estimation model M1 for estimating the streaming quality using, as an input, a time series of packet statistical values corresponding to a time length exceeding a buffer time of the streaming data at the transmission destination.

As a result, the streaming quality estimation devices 1 and 1b can create the estimation model M1 for estimating the streaming quality using packet statistical values finer than packet statistical values calculated as one large time window while eliminating the deviation between the packet arrival time and the data reproduction time due to the buffer time. That is, the streaming quality estimation devices 1 and 1b can create the estimation model M1 capable of estimating the streaming quality accurately in real time.

In addition, on the basis of packet statistical values calculated on the basis of packets related to estimation target streaming data, the streaming quality estimation devices 1 and 1b input, to the estimation model M1, a time series of packet statistical values corresponding to a time exceeding the buffer time of the streaming data at the transmission destination of the estimation target streaming data, and estimate the streaming quality of the estimation target streaming data.

As a result, the streaming quality estimation devices 1 and 1b can estimate the streaming quality of the estimation target streaming data using packet statistical values finer than packet statistical values calculated as one large time window while eliminating the deviation of the data reproduction time due to the buffer time. That is, the streaming quality estimation devices 1 and 1b can estimate the streaming quality accurately in real time.

In addition, the streaming quality estimation device 1b inputs a time series of packet statistical values based on the estimation target streaming data to each of the plurality of estimation models M1a, M1b, and M1c that differ from each other in time length of the time series of packet statistical values used as an input. Next, the streaming quality estimation device 1b estimates the buffer time on the basis of the accuracies of the estimation results of the plurality of estimation models M1a, M1b, and M1c. Thus, for example, even in a case where the buffer time of the streaming data at the transmission destination is unknown, the streaming quality estimation device 1b can estimate the buffer time on the basis of the packet statistical values.

Note that each component of each device illustrated in the drawings does not always need to be configured physically as illustrated in the drawings. That is, a specific form of distribution and integration of the devices is not limited to that illustrated in the drawings, and all or a part thereof can be functionally or physically distributed or integrated in an any unit in accordance with various loads, usage conditions, and the like.

Furthermore, all or any part of various process functions of the packet collection unit 10, the statistical value calculation unit 11, the estimation model creation unit 12, the streaming quality estimation unit 13, and the buffer time estimation unit 14 of the streaming quality estimation devices 1, 1b, and 1c may be executed on a CPU (or a micro computer such as an MPU or a micro controller unit (MCU)). Furthermore, it is needless to say that all or any part of the various process functions may be executed on a program analyzed and executed by a CPU (or a micro computer such as an MPU or an MCU) or on hardware by wired logic. Furthermore, the various process functions performed in the streaming quality estimation device 1 may be executed by a plurality of computers in cooperation by cloud computing.

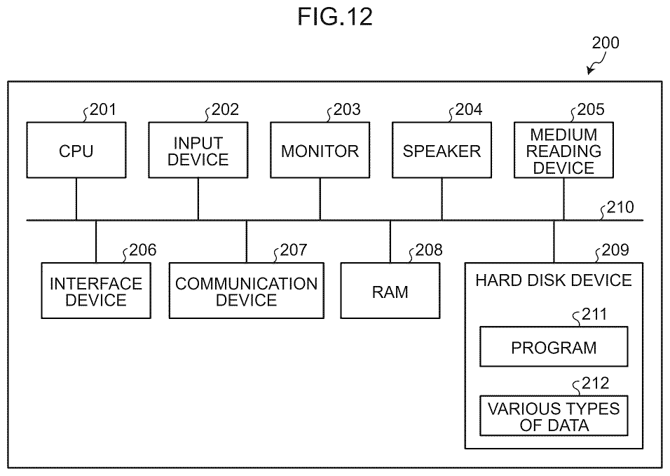

The various processes described in the above embodiment can be achieved by causing a computer to execute a program prepared in advance. Thus, an example of a computer configuration (hardware) for executing a program having functions similar to those of the above embodiment will be described below. FIG. 12 is an explanatory diagram illustrating an example of the computer configuration.

As illustrated in FIG. 12, a computer 200 includes a CPU 201 that executes various types of arithmetic process, an input device 202 that accepts data input, a monitor 203, and a speaker 204. In addition, the computer 200 includes a medium reading device 205 that reads a program or the like from a storage medium, an interface device 206 for connection with various devices, and a communication device 207 for wired or wireless communication and connection with an external device. Furthermore, the streaming quality estimation device 1 includes a RAM 208 that temporarily stores various types of information and a hard disk device 209. Each unit (201 to 209) in the computer 200 is connected to a bus 210.

The hard disk device 209 stores a program 211 for executing various processes in the functional configuration (for example, the packet collection unit 10, the statistical value calculation unit 11, the estimation model creation unit 12, the streaming quality estimation unit 13, and the buffer time estimation unit 14) described in the above embodiment. In addition, the hard disk device 209 stores various types of data 212 to be referred to by the program 211. The input device 202 accepts an input of operation information from an operator, for example. The monitor 203 displays, for example, various screens for the operator to perform an operation. The interface device 206 is connected with, for example, a printing device or the like. The communication device 207 is connected to a communication network such as a local area network (LAN), and exchanges various types of information with an external device via the communication network.

The CPU 201 reads the program 211 stored in the hard disk device 209, develops the program in the RAM 208, and executes the program, thereby performing various processes related to the functional configuration (for example, the packet collection unit 10, the statistical value calculation unit 11, the estimation model creation unit 12, the streaming quality estimation unit 13, and the buffer time estimation unit 14). Note that it is possible that the program 211 is not stored in the hard disk device 209. For example, the program 211 stored in a storage medium readable by the computer 200 may be read and executed. The storage medium readable by the computer 200 corresponds to, for example, a portable recording medium such as a CD-ROM, a DVD disk, or a universal serial bus (USB) memory, a semiconductor memory such as a flash memory, a hard disk drive, or the like. Alternatively, the program 211 may be stored in a device connected to a public line, the Internet, a LAN, or the like, and the computer 200 may read and execute the program 211 from the device.

The streaming quality can be estimated accurately in real time.

All examples and conditional language recited herein are intended for pedagogical purposes of aiding the reader in understanding the invention and the concepts contributed by the inventors to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A non-transitory computer-readable recording medium having stored therein a program that causes a computer to execute a process comprising:
collecting packets related to streaming data delivered from a transmission source to a transmission destination;
calculating a packet statistical value of a predetermined time period based on the collected packets; and
creating, based on the calculated packet statistical value, an estimation model for estimating streaming quality using, as an input, a time series of packet statistical values corresponding to a time length exceeding a buffer time of the streaming data at the transmission destination.

2. The non-transitory computer-readable recording medium according to claim 1, wherein
the process further includes:
inputting to the estimation model, based on packet statistical values calculated based on packets related to estimation target streaming data, a time series of packet statistical values corresponding to a time exceeding the buffer time of the streaming data at the transmission destination of the estimation target streaming data; and
estimating the streaming quality of the estimation target streaming data.

3. The non-transitory computer-readable recording medium according to claim 2, wherein
the process further includes:
inputting a time series of packet statistical values based on the estimation target streaming data to each of a plurality of the estimation models that differ from each other in time length of the time series of packet statistical values used as an input; and
estimating the buffer time based on accuracies of estimation results of the plurality of the estimation models.

4. A streaming quality estimation method comprising:
collecting packets related to streaming data delivered from a transmission source to a transmission destination;
calculating a packet statistical value of a predetermined time period based on the collected packets; and
creating, based on the calculated packet statistical value, an estimation model for estimating streaming quality using, as an input, a time series of packet statistical values corresponding to a time length exceeding a buffer time of the streaming data at the transmission destination, using a processor.

5. The streaming quality estimation method according to claim 4, wherein
the streaming quality estimation method further includes:
inputting to the estimation model, based on packet statistical values calculated based on packets related to estimation target streaming data, a time series of packet statistical values corresponding to a time exceeding the buffer time of the streaming data at the transmission destination of the estimation target streaming data, and estimating the streaming quality of the estimation target streaming data.

6. The streaming quality estimation method according to claim 5, wherein
the streaming quality estimation method further includes:
inputting a time series of packet statistical values based on the estimation target streaming data to each of a plurality of the estimation models that differ from each other in time length of the time series of packet statistical values used as an input, and
estimating the buffer time based on accuracies of estimation results of the plurality of the estimation models.

7. A streaming quality estimation device comprising:
a processor configured to:
collect packets related to streaming data delivered from a transmission source to a transmission destination;
calculate a packet statistical value of a predetermined time period based on the collected packets; and
create, based on the calculated packet statistical value, an estimation model for estimating streaming quality using, as an input, a time series of packet statistical values corresponding to a time length exceeding a buffer time of the streaming data at the transmission destination.

8. The streaming quality estimation device according to claim 7, wherein
the processor is futher configured to:
input to the estimation model, based on packet statistical values calculated based on packets related to estimation target streaming data, a time series of packet statistical values corresponding to a time exceeding the buffer time of the streaming data at the transmission destination of the estimation target streaming data, and
estimate the streaming quality of the estimation target streaming data.

9. The streaming quality estimation device according to claim 8, wherein
the processor is futher configured to:
input a time series of packet statistical values based on the estimation target streaming data to each of a plurality of the estimation models that differ from each other in time length of the time series of packet statistical values used as an input, and
estimate the buffer time based on accuracies of estimation results of the plurality of the estimation models.
